(19) United States
(12) Patent Application Publication
(10) Pub. No.: US 2026/0147552 A1
(43) Pub. Date: May 28, 2026

(54) CONTEXTUALLY EMBEDDED PRODUCTION REPORTING TOOLS IN INTEGRATED DEVELOPMENT ENVIRONMENTS

(71) Applicant: WORKDAY, INC., Pleasanton, CA (US)

(72) Inventors: Cathal COURTNEY, Dublin (IE); Ian THACKSTON, San Diego, CA (US); Bindu RACHAKONDA, Pleasanton, CA (US); Gordon HARRINGTON, Dublin (IE); Minal Popatbhai PATEL, Pleasanton, CA (US); Joshua HENDRICKS, Pleasanton, CA (US)

(21) Appl. No.: 18/958,198

(22) Filed: Nov. 25, 2024

(51) Int. Cl. G06F 8/41

(52) U.S. Cl. CPC G06F 8/427

(57) ABSTRACT

In some implementations, the techniques described herein relate to a method including: receiving, by a processor, a request to view code in an integrated development environment (IDE); extracting, by the processor, context information from the code; selecting, based on the context information, at least one production reporting tool from a tool repository; retrieving production data associated with the code from at least one data source; generating a report using the production data; and embedding the report within a user interface of the IDE while displaying the code.

### BACKGROUND

Integrated Development Environments (IDEs) are software applications that provide facilities to computer programmers for software development. These environments often include a source code editor, build automation tools, a debugger, and similar tools. Modern IDEs often incorporate additional features such as version control systems, multiple programming language support, code completion, and artificial intelligence (AI) copilots.

### BRIEF DESCRIPTION OF THE DRAWINGS

FIG. 1 illustrates a system for providing contextually embedded production reporting tools in an integrated development environment (IDE).

FIG. 2 illustrates a method for embedding production tools in an IDE.

FIG. 3 illustrates a method for updating embedded production tools in an IDE.

FIG. 4 illustrates a method for adding a new embedded production reporting tool to an IDE.

FIG. 5 illustrates a method for AI-assisted production reporting within an IDE.

FIG. 6 is a block diagram of a computing device according to some embodiments of the disclosure.

### DETAILED DESCRIPTION

The present disclosure relates to systems and methods for integrating production reporting tools directly into IDEs. This integration allows developers to access real-time production data and insights within the context of their development workflow, without leaving their coding environment.

In some implementations, the system comprises a backend server that communicates with the IDE running on a developer's workstation. The backend server includes various components including, without limitation, a context extractor, a tool selector, a data retriever, a report generator, and a notification system. These components analyze the code being viewed in the IDE, select relevant production reporting tools, retrieve pertinent data, and present it to the developer in an easily digestible format.

When a developer views or edits code in the IDE, the context extractor analyzes the code to determine its purpose and functionality. Based on this context, the tool selector identifies relevant production reporting tools from a repository. The data retriever then fetches the necessary production data from various data sources. The report generator compiles this data into meaningful reports, which are then embedded directly into the IDE's interface through embedded production tools (EPTs).

This solution addresses several key challenges unique to the development of computer software. First, it improves the discoverability of production reporting tools by presenting them contextually within the IDE. This reduces the time developers spend searching for relevant tools and data. Second, it enhances the usability of these tools by integrating them seamlessly into the development workflow. Developers can now access critical production insights without context-switching between multiple applications. Finally, the system promotes a “shift left” approach in software development by making production data readily available earlier in the development process, allowing potential issues to be identified and addressed sooner.

In some implementations, the system can also include an AI copilot feature that can assist developers in interpreting the production data and suggest potential optimizations or solutions to identified issues. This further enhances the value of the embedded production reporting tools by providing intelligent, context-aware assistance to developers.

By bringing production insights directly into the development environment, this system enables developers to make more informed decisions, improve code quality, and ultimately deliver better software products more efficiently.

In some implementations, the techniques described herein relate to a method including: receiving, by a processor, a request to view code in an integrated development environment (IDE); extracting, by the processor, context information from the code; selecting, based on the context information, at least one production reporting tool from a tool repository; retrieving production data associated with the code from at least one data source; generating a report using the production data; and embedding the report within a user interface of the IDE while displaying the code.

In some implementations, the techniques described herein relate to a method, wherein extracting context information includes: parsing the code to generate an abstract syntax tree; analyzing the abstract syntax tree to identify code structures; and determining a purpose of the code based on the code structures.

In some implementations, the techniques described herein relate to a method, wherein selecting the at least one production reporting tool includes: querying a tool repository containing metadata about available production reporting tools; matching the context information with the metadata; and identifying tools applicable to the code based on matching the context information with the metadata.

In some implementations, the techniques described herein relate to a method, wherein retrieving production data includes: authenticating with the at least one data source; constructing queries based on the context information; and executing the queries to generate performance metrics associated with the code.

In some implementations, the techniques described herein relate to a method, further including: monitoring changes to the code in the IDE; updating the context information based on the changes; and refreshing the report based on the context information.

In some implementations, the techniques described herein relate to a method, wherein embedding the report includes: selecting a location within the IDE based on a type of the report; generating a visualization of the production data; and displaying the visualization in the location while maintaining visibility of the code.

In some implementations, the techniques described herein relate to a method, further including: analyzing the production data using an artificial intelligence model; generating recommendations for code optimization based on an output of the artificial intelligence model; and presenting the recommendations within the report.

In some implementations, the techniques described herein relate to a non-transitory computer-readable storage medium for tangibly storing computer program instructions capable of being executed by a computer processor, the computer program instructions defining steps of: receiving, by a processor, a request to view code in an integrated development environment (IDE); extracting, by the processor, context information from the code; selecting, based on the context information, at least one production reporting tool from a tool repository; retrieving production data associated with the code from at least one data source; generating a report using the production data; and embedding the report within a user interface of the IDE while displaying the code.

In some implementations, the techniques described herein relate to a non-transitory computer-readable storage medium, wherein extracting context information includes: parsing the code to generate an abstract syntax tree; analyzing the abstract syntax tree to identify code structures; and determining a purpose of the code based on the code structures.

In some implementations, the techniques described herein relate to a non-transitory computer-readable storage medium, wherein selecting the at least one production reporting tool includes: querying a tool repository containing metadata about available production reporting tools; matching the context information with the metadata; and identifying tools applicable to the code based on matching the context information with the metadata.

In some implementations, the techniques described herein relate to a non-transitory computer-readable storage medium, wherein retrieving production data includes: authenticating with the at least one data source; constructing queries based on the context information; and executing the queries to generate performance metrics associated with the code.

In some implementations, the techniques described herein relate to a non-transitory computer-readable storage medium, the steps further including: monitoring changes to the code in the IDE; updating the context information based on the changes; and refreshing the report based on the context information.

In some implementations, the techniques described herein relate to a non-transitory computer-readable storage medium, wherein embedding the report includes: selecting a location within the IDE based on a type of the report; generating a visualization of the production data; and displaying the visualization in the location while maintaining visibility of the code.

In some implementations, the techniques described herein relate to a non-transitory computer-readable storage medium, the steps further including: analyzing the production data using an artificial intelligence model; generating recommendations for code optimization based on an output of the artificial intelligence model; and presenting the recommendations within the report.

In some implementations, the techniques described herein relate to a device including: a processor; and a memory storing instructions that, when executed by the processor, cause the processor to perform steps of: receiving, by a processor, a request to view code in an integrated development environment (IDE); extracting, by the processor, context information from the code; selecting, based on the context information, at least one production reporting tool from a tool repository; retrieving production data associated with the code from at least one data source; generating a report using the production data; and embedding the report within a user interface of the IDE while displaying the code.

In some implementations, the techniques described herein relate to a device, wherein extracting context information includes: parsing the code to generate an abstract syntax tree; analyzing the abstract syntax tree to identify code structures; and determining a purpose of the code based on the code structures.

In some implementations, the techniques described herein relate to a device, wherein selecting the at least one production reporting tool includes: querying a tool repository containing metadata about available production reporting tools; matching the context information with the metadata; and identifying tools applicable to the code based on matching the context information with the metadata.

In some implementations, the techniques described herein relate to a device, wherein retrieving production data includes: authenticating with the at least one data source; constructing queries based on the context information; and executing the queries to generate performance metrics associated with the code.

In some implementations, the techniques described herein relate to a device, the steps further including: monitoring changes to the code in the IDE; updating the context information based on the changes; and refreshing the report based on the context information.

In some implementations, the techniques described herein relate to a device, wherein embedding the report includes: selecting a location within the IDE based on a type of the report; generating a visualization of the production data; and displaying the visualization in the location while maintaining visibility of the code.

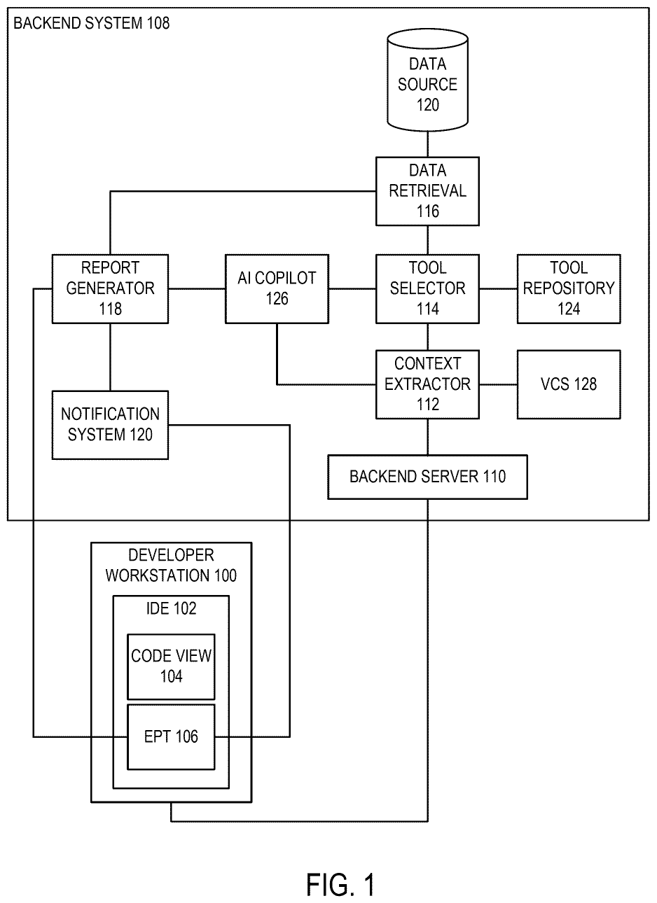

FIG. 1 illustrates a system for providing contextually embedded production reporting tools in an integrated development environment (IDE). As illustrated, the system includes several interconnected components that work together to provide developers with production insights within their coding environment.

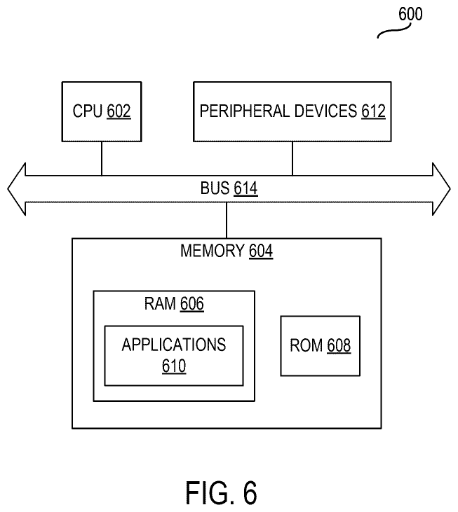

The developer workstation 100 can comprise a local machine (e.g., similar to that depicted in FIG. 6) where a developer performs coding tasks. In some implementations, the developer workstation 100 hosts, or otherwise displays, an IDE 102, a software application that provides facilities for software development. In some implementations, the IDE 102 can comprise a desktop or web-based IDE and the disclosure is not limited as such.

The IDE 102 includes a code view 104, which is an interface where developers write, edit, and review code. Integrated within the IDE 102 is the embedded production tools 106, which serves as the interface for displaying production reports and insights within the developer's workflow.

The developer workstation 100 communicates with the backend server 110 via a network 108. This network can be implemented as a local area network (LAN) for on-premises hosting, or a wide area network (WAN) such as the Internet for cloud-based implementations. The network communication can use protocols such as HTTP, HTTPS, or WebSocket, depending on the requirements for data transfer and security.

The backend server 110 contains the ingress and egress logic and processing capabilities of the system. It can be implemented as a single physical server or as a distributed system spanning multiple servers or cloud instances. It may also comprise a computing device such as that depicted in FIG. 6. In some implementations, the backend server 110 may receive code (e.g., snippets, files, code bases, etc.) and transmit that code to context extractor 112.

In some implementations, the context extractor 112 analyzes the code currently being viewed or edited in the code view 104. It parses the code to understand its structure, purpose, and context. This component can be implemented using code analysis techniques, such as abstract syntax tree (AST) parsing, semantic analysis, or machine learning-based code understanding models. The context extractor 112 may integrate with the version control system (VCS) 128 to gather additional context about the code, such as its revision history, associated tickets or issues, and relationships with other parts of the codebase. The version control system (VCS) 128 manages code versions and provides additional context for the embedded production tools. VCS 128 allows for features such as correlating production metrics with specific code changes, tracking the evolution of performance over time as code changes, and providing historical context for production issues.

The tool selector 114 uses the context provided by the context extractor 112 to identify which production reporting tools are relevant to the code being viewed. It interfaces with the tool repository 124, which maintains a catalog of available reporting tools along with metadata about their purposes and applicable contexts. The tool selector 114 can employ selection algorithms, from rule-based systems to machine learning models that learn from usage patterns and feedback over time.

The tool repository 124 serves as a storage and management system for all available production reporting tools. It stores the tools and maintains metadata about each tool's purpose, applicable contexts, required inputs, and output formats. This repository can be implemented as a database with an API layer, allowing for addition, update, and removal of tools. In some implementations, the tool repository 124 is designed as an open system where all developers within the organization can contribute. This collaborative approach encourages the sharing of specialized tools and knowledge across teams, fostering a culture of continuous improvement and innovation in production reporting capabilities.

The data retriever 116 fetches the necessary production data from various data source 122. This data source can include application logs, performance monitoring systems, user analytics platforms, and other production telemetry systems. The data retriever 116 interfaces with a variety of data storage and retrieval systems, potentially including relational databases, NoSQL databases, time-series databases, and real-time streaming platforms. It handles authentication and authorization to ensure secure access to production data. The data source 122 represent the systems and databases that store production data. These can include application performance monitoring (APM) tools, log aggregation systems, user analytics platforms, and custom telemetry systems. The nature and number of these data sources depend on the specific software system being developed and monitored.

The report generator 118 takes the raw data from the data retriever 116 and transforms it into insights. This component can leverage data processing and visualization libraries to create charts, graphs, and other visual representations of the data. The report generator 118 can allow for the addition of new report types and visualizations as needed.

The notification system 120 alerts developers to updates or insights that may require their attention. This can include notifications about changes in production metrics, newly available reports, or potential issues detected in the code based on production data. The notification system 120 can be implemented using mechanisms such as in-IDE notifications, email alerts, or integration with team communication platforms.

The AI copilot 126 provides assistance to developers based on the production data and code context. It can be implemented using natural language processing and machine learning models, potentially leveraging large language models fine-tuned on code and software development tasks. The AI copilot 126 can offer suggestions for code optimizations, help interpret production metrics, or generate code snippets to address identified issues.

The system is designed with modularity and extensibility. Each component can be developed, updated, and scaled independently, allowing for flexibility in implementation and future enhancements. For example, the backend server 110 can be implemented as a microservices architecture, with each component running as a separate service. This allows for independent scaling of components based on load and updates or replacements of individual components.

The system implements security measures, particularly for its access to production data. Communication between components, especially between the developer workstation 100 and the backend server 110, is encrypted. The system implements authentication and authorization mechanisms to ensure that developers have access to the production data they're permitted to see. This can involve integration with the organization's existing identity and access management systems.

The system is designed with performance considerations. Given that it operates within an IDE, the embedded production tools are implemented to minimize impact on the IDE's responsiveness. This can involve techniques such as asynchronous data loading, caching mechanisms, and optimized data transfer protocols.

The embedded production tools 106 within the IDE 102 are designed to be accessible while minimizing interference with the primary coding interface. This can involve collapsible panels, hover-activated overlays, or other UI patterns that provide information without cluttering the interface.

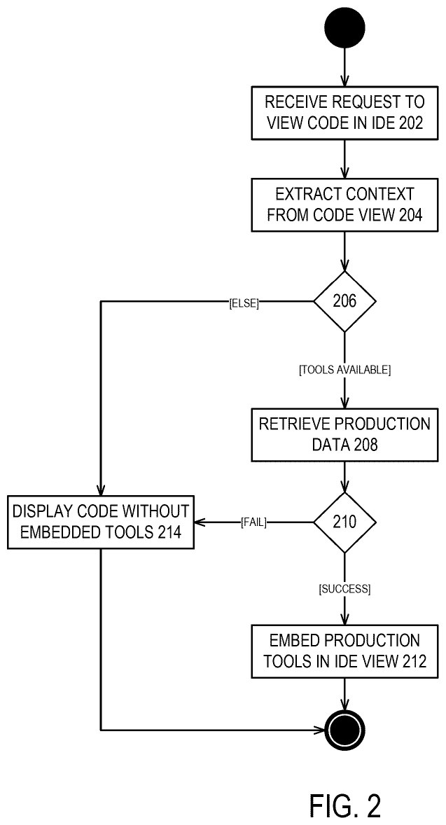

The system includes logging and monitoring capabilities to track its performance and usage patterns. This monitoring can assist in improving the system, identifying tool usage patterns, and ensuring system performance. In general, one or more computing devices, such as that depicted in FIG. 6, can be used to implement the illustrated system. Further functional details of the above system are described next with respect to FIGS. 2 through 5.

FIG. 2 illustrates a method for embedding production tools in an IDE.

In step 202, the method can include receiving a request to view code in the IDE.

This request typically originates from a developer interacting with the IDE on their workstation. The request can be triggered by various actions, such as opening a file, navigating to a specific function or class, or switching between different code views within the IDE. The IDE may be a standalone application or a web-based development environment, and the code being viewed could be in any programming language supported by the IDE. The request serves as the entry point for the contextual embedding of production tools.

In step 204, the method can include extracting context from the code view.

Context extraction involves analyzing the code currently visible in the IDE to understand its purpose, structure, and relationships. This process can employ various techniques, including AST parsing, semantic analysis, and machine learning-based code understanding models. The context extractor may consider factors such as the programming language, file name, class and function names, variable declarations, and comments within the code. It may also take into account the project structure, package dependencies, and any associated metadata.

Additionally, the context extraction process can integrate with version control systems to gather historical information about the code, such as recent changes, authors, and related issue tickets. This broader context can be valuable for selecting relevant production tools and interpreting the data they provide.

The depth and breadth of context extraction can be configurable, allowing organizations to balance the richness of context against performance considerations. For instance, a lightweight extraction might focus only on the immediate scope of the visible code, while a more comprehensive extraction could analyze the entire file or even related files within the project.

In step 206, the method can include determining whether relevant production tools are available based on the extracted context.

This step can include querying a tool repository or catalog to identify production tools that are applicable to the current code context. The selection process can use various criteria, such as the programming language, the type of code (e.g., frontend, backend, database queries), the specific libraries or frameworks in use, and any performance-critical operations identified in the code.

The tool selection algorithm can range from rule-based systems to machine learning models. A rule-based system might use predefined mappings between code characteristics and tool applicability. For example, if the code contains database queries, it might select tools for monitoring query performance and database load. Conversely, a machine learning-based selector could learn from historical usage patterns, developer feedback, and the effectiveness of tool recommendations over time. This approach allows the method to improve its selections and adapt to evolving development practices and toolsets. The selection process may also consider any access restrictions or permissions associated with the tools, ensuring that only tools the current developer is authorized to use are selected.

If no relevant tools are available, the method proceeds to step 214. If relevant tools are identified, the method continues to step 208.

In step 208, the method can include retrieving production data for the selected tools.

This step can include fetching the necessary data from various production data sources. The data retrieval process is typically handled by a dedicated component that can interface with a wide range of data storage and retrieval systems. These may include APM tools, log aggregation systems, user analytics platforms, time-series databases, and custom telemetry systems. The method can be capable of handling different data formats, query languages, and APIs specific to each data source. It can also implement appropriate authentication and authorization mechanisms to ensure secure access to sensitive production data.

The retrieval process can be optimized for performance through techniques such as caching frequently accessed data, implementing efficient query strategies, and using data streaming for real-time updates where applicable. The method may also implement data sampling or aggregation techniques for large datasets to balance the level of detail with retrieval and processing speed.

In addition to raw data, the retriever may also fetch relevant metadata, such as the time range of the data, the number of production instances it represents, and any known data quality issues or caveats.

In step 210, the method can include determining whether the data retrieval was successful.

This step can include validating the retrieved data to ensure it meets the necessary criteria for use in the embedded production tools. The validation process can check for factors such as data completeness, freshness, and consistency.

Data completeness checks ensure that all required data points for the selected tools are present. For instance, if a performance monitoring tool requires both response time and error rate data, the method verifies that both metrics are available.

Data freshness checks confirm that the retrieved data is recent enough to be relevant for the current analysis. The acceptable age of data may vary depending on the nature of the tool and the specific metrics involved. For example, data for real-time monitoring tools might need to be no more than a few minutes old, while data for long-term trend analysis could be accepted even if it's a few hours or days old.

Consistency checks look for any anomalies or contradictions in the data that might indicate retrieval or processing errors. This could involve cross-referencing different metrics, comparing data from multiple sources, or applying statistical techniques to identify outliers.

If the data retrieval is determined to be unsuccessful, the method proceeds to step 214. If the data retrieval is successful, the method continues to step 212.

In step 212, the method can include embedding production tools in the IDE view.

This step can include integrating the selected production tools and their associated data into the IDE's user interface. The embedding process may be designed to provide insights without disrupting the developer's workflow or cluttering the coding environment.

The embedded tools can take various forms. As a first example, the embedded tools may take the form of inline annotations which may be small indicators or icons placed directly within the code, providing quick insights or warnings related to specific lines or blocks of code. As a second example, the embedded tools may take the form of margin widgets which may be information panels or expandable sections displayed in the margins of the code editor, offering more detailed data without obscuring the code itself. As a third example, the embedded tools may take the form of overlay panels which may be floating windows or panels that can be toggled on and off, providing comprehensive data visualizations and interactive features. As a fourth example, the embedded tools may take the form of status bar indicators which may be compact displays in the IDE's status bar, showing high-level metrics or alerts that are always visible but unobtrusive. As a fifth example, the embedded tools may take the form of context-sensitive tooltips which may be detailed information that appears when hovering over specific code elements, combining code documentation with relevant production data.

The embedding process may consider the layout and design conventions of the specific IDE to ensure a consistent and intuitive user experience. It may also implement smooth animations and transitions to minimize visual disruption when tools are shown or hidden. For performance reasons, the method may implement progressive loading of embedded tools, starting with lightweight, high-level information and allowing developers to drill down into more detailed data on demand.

The embedded tools may be interactive, allowing developers to adjust time ranges, filter data, or pivot between different metrics without leaving the IDE. This interactivity can be implemented using web technologies for maximum flexibility, or native UI components for tighter integration with the IDE.

In step 214, the method can include displaying the code without embedded tools. This step is reached if no relevant production tools are available for the current code context, or if the data retrieval process was unsuccessful. In this case, the IDE displays the requested code view in its standard format, without any additional production data or tool integrations.

Even when no tools are embedded, the method may still provide indications that production tooling is available in general, such as a small icon in the IDE's toolbar. This helps maintain awareness of the feature and encourages developers to investigate why tools aren't available for the current context, potentially leading to improvements in tool coverage or data availability.

The method may also log the reasons for not embedding tools in this instance, such as lack of relevant tools or data retrieval failures. This logging can be valuable for system administrators and tool developers to identify gaps in coverage or issues with data retrieval that need to be addressed.

While no production tools are embedded in this case, the IDE may remain responsive to future opportunities for embedding. For example, if the developer switches to a different part of the code where tools are available, or if data retrieval issues are resolved, the method may be ready to embed tools without requiring a manual refresh or restart of the IDE. The method's versatility is demonstrated through various use cases. For instance, when viewing class model definitions, developers can access embedded dashboards showing production volumes grouped by customer. This insight helps in optimizing data access and storage patterns based on actual usage. Another use case involves analyzing user input performance, where developers can identify and optimize poorly performing form fields. The method also supports examining API level objectives, providing visibility into API usage patterns and error rates directly within the API definition view. Additionally, for background jobs, the method enables performance profiling and triage, allowing developers to understand job execution times and success rates before introducing new logic.

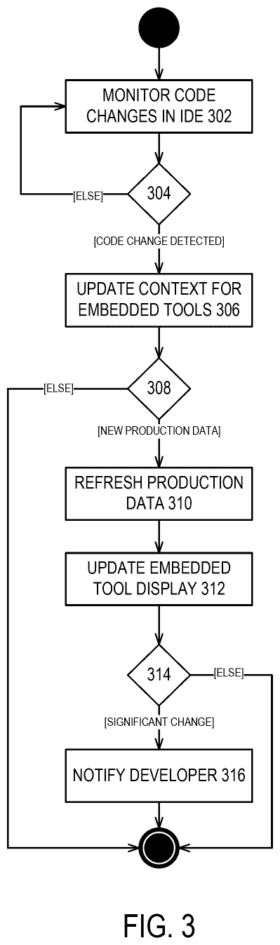

FIG. 3 illustrates a method for updating embedded production tools in an IDE.

In step 302, the method can include monitoring code changes in the IDE.

This step can include continuously observing the developer's actions within the IDE to detect modifications to the code. The monitoring process can be implemented using event listeners or hooks provided by the IDE's extensibility framework. These listeners can capture a wide range of events, including keystrokes, copy-paste operations, file saves, and version control actions. The granularity of change detection can be adjusted based on performance considerations and the desired responsiveness of the embedded tools. For instance, the method might update on every keystroke for maximum responsiveness, or it might wait for natural pauses in typing or explicit save actions to reduce processing overhead. The monitoring process may be designed to be lightweight and non-intrusive, avoiding any noticeable impact on the IDE's performance or the developer's workflow.

In step 304, the method can include determining whether a relevant code change has been detected.

This step can include analyzing the monitored changes to determine if they are significant enough to warrant an update of the embedded production tools. The relevance of a change can be assessed based on various factors, such as the scope of the modification, the type of code element affected, and the potential impact on system behavior or performance. For example, changes to variable names or comments might be considered less relevant, while modifications to logic flow, database queries, or API calls could be deemed highly relevant. The method may employ heuristics or machine learning models to classify changes and estimate their potential impact. This classification process helps filter out minor or cosmetic changes that are unlikely to affect production metrics, focusing the system's resources on updates that are more likely to provide valuable insights to the developer.

If no relevant code change is detected, the method returns to step 302 to continue monitoring. If a relevant change is detected, the method proceeds to step 306.

In step 306, the method can include updating the context for embedded tools.

When a relevant code change is detected, the system needs to reassess the context of the code to ensure that the embedded tools remain applicable and accurate. This context update process is similar to the initial context extraction described in FIG. 2, but it can be optimized to focus on the specific areas of the code that have changed. The context updater analyzes the modified code sections, considering factors such as the new structure, introduced or removed dependencies, and changes in logic or data flow. It may also take into account the broader context of the file or project, as localized changes can sometimes have far-reaching implications. The updated context information is then used to reevaluate the relevance of currently embedded tools and identify any new tools that may have become applicable due to the changes.

In step 308, the method can include determining whether new production data is available based on the updated context.

This step can include querying the production data sources to check for any new or updated data that is relevant to the modified code. The availability of new data can depend on various factors, such as the nature of the code changes, the frequency of data collection in the production environment, and the latency of data processing and aggregation systems. For some types of metrics, like real-time performance data, new information might be available almost immediately. For others, such as long-term usage statistics or aggregated error rates, it may take longer for new data to become available. The method may implement different checking strategies for different types of data, balancing the need for up-to-date information with the desire to minimize unnecessary data retrieval operations.

If no new production data is available, the method proceeds to step 314. If new data is available, the method continues to step 310.

In step 310, the method can include refreshing the production data.

When new relevant data is available, This step can include fetching the updated information from the appropriate production data sources. The data refresh process can be optimized to retrieve only the new or changed data, rather than reloading all information. This can be achieved through techniques such as incremental data fetching, where only data points newer than the last update are retrieved, or differential updates, where only the changes since the last fetch are transmitted. The refresh process may handle potential issues such as data inconsistencies or temporary unavailability of data sources, implementing appropriate error handling and retry mechanisms. Once the new data is retrieved, it is processed and prepared for presentation in the embedded tools, which may involve data transformation, aggregation, or correlation with other metrics.

In step 312, the method can include updating the embedded tool display.

This step can include modifying the visual representation of the embedded production tools to reflect the newly refreshed data. The update process may be designed to be smooth and non-disruptive, maintaining the developer's focus on their primary coding tasks. This can be achieved through techniques such as subtle animations for changing values, gradual fading in of new information, or using visual cues to highlight specific changes. The system may be capable of updating different types of visualizations, including charts, graphs, heatmaps, and textual summaries. In cases where the changes to the data are substantial, the system might need to adjust the scale or layout of visualizations to accommodate new ranges or data points. The update process may also handle cases where previously displayed data is no longer relevant due to code changes, gracefully removing or archiving this information.

In step 314, the method can include determining whether the changes are significant enough to notify the developer.

This step can include evaluating the magnitude and potential impact of the changes in both the code and the associated production data. The significance of changes can be assessed using predefined thresholds, statistical analysis, or machine learning models trained on historical data and developer feedback. Factors considered might include the degree of change in key metrics, the emergence of new patterns or anomalies, or the crossing of predefined performance or quality thresholds. The system may be configurable to allow organizations or individual developers to set their own criteria for what constitutes a significant change worthy of notification.

If the changes are not deemed significant, the method returns to step 302 to continue monitoring. If the changes are significant, the method proceeds to step 316.

In step 316, the method can include notifying the developer of the updates.

When significant changes are detected, This step can include alerting the developer to the new information in a timely but non-intrusive manner. The notification mechanism can take various forms depending on the IDE's capabilities and the developer's preferences. This might include subtle visual indicators within the IDE, such as changing icon colors or displaying small badges. For more critical updates, the system might use more prominent notifications like pop-up messages or toast notifications. The notifications may be designed to provide a quick summary of the important changes, with options for the developer to easily access more detailed information if desired. The system may also integrate with external notification channels, such as email or team communication platforms, for updates that require attention even when the developer is not actively using the IDE.

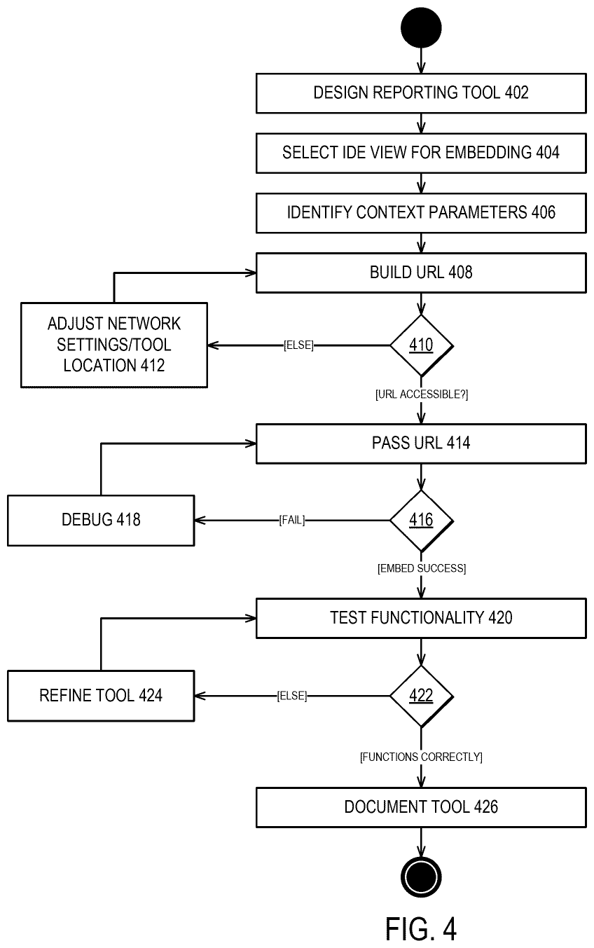

FIG. 4 illustrates a method for adding a new embedded production reporting tool to an IDE.

In step 402, the method can include designing a reporting tool with a web interface.

This step can include creating a new production reporting tool that can be embedded within the IDE. The tool may be designed with a web-based interface to ensure compatibility with the embedding system. The design process considers factors such as the type of data the tool will present, the visualizations it will use, and the interactivity it will offer to developers. The tool's interface may be responsive and adaptable to different screen sizes and layouts within the IDE. Designers and developers collaborate to create a user experience that aligns with the IDE's overall look and feel while providing clear and actionable insights. The tool may incorporate various web technologies such as HTML5, CSS3, and JavaScript frameworks to create rich, interactive visualizations. Consideration is given to performance optimization, ensuring that the tool loads quickly and operates smoothly within the IDE environment.

In step 404, the method can include selecting the IDE view for embedding the tool.

This step can include identifying the most appropriate location within the IDE where the new reporting tool will be displayed. The selection process considers the nature of the tool, the type of data it presents, and how developers are likely to use it in their workflow. Possible embedding locations might include sidebars, bottom panels, or overlay windows. The choice of location balances visibility and easy access with the need to avoid cluttering the main coding area. Consideration is also given to how the tool will coexist with other embedded tools and IDE features. The selection process may involve user testing or feedback from experienced developers to ensure that the chosen location enhances rather than disrupts the development workflow.

In step 406, the method can include identifying context parameters from the IDE view.

This step can include determining what information from the IDE and the current code context is necessary for the reporting tool to function effectively. Context parameters might include the current file name, the programming language in use, function or class names, or specific code elements like database queries or API calls. The identification process considers both the minimum information required for the tool to operate and additional context that could enhance its functionality or accuracy. Developers analyze how the tool will interact with different types of code and IDE states to ensure that all necessary context is captured. This step may also involve defining how the context parameters will be formatted and passed to the reporting tool, ensuring compatibility with the tool's input requirements.

In step 408, the method can include building a URL with the identified context parameters.

This step can include constructing a URL that will be used to load the reporting tool with the appropriate context. The URL typically includes the base address of the reporting tool's web interface, along with query parameters that represent the context information identified in the previous step. The URL construction process ensures that all necessary information is properly encoded and formatted according to URL standards. Developers implement logic to dynamically generate this URL based on the current IDE state and code context. The method may also include mechanisms for handling special characters, long parameter values, or sensitive information that needs to be securely transmitted. The URL construction process is designed to be flexible, allowing for easy addition or modification of parameters as the tool's capabilities evolve.

In step 410, the method can include determining whether the constructed URL is accessible within the network.

This step can include verifying that the reporting tool can be reached using the constructed URL from within the development environment's network. The accessibility check may involve sending a test request to the URL and validating the response. This process ensures that there are no network configuration issues, firewalls, or access controls preventing the IDE from reaching the reporting tool. The method may implement retry logic with exponential backoff to handle temporary network issues. If the URL is not accessible, the method proceeds to step 412. If the URL is accessible, the method continues to step 414.

In step 412, the method can include adjusting network settings or the tool's location to ensure accessibility.

If the URL is not accessible, this step can include troubleshooting and resolving the connectivity issues. This may include working with network administrators to adjust firewall rules, updating DNS configurations, or modifying network routing. In some cases, it might involve relocating the reporting tool to a different server or adjusting its configuration to allow access from the development environment. The process may also include updating any authentication or authorization settings to ensure that the IDE has the necessary permissions to access the tool. Once adjustments are made, the system retests the accessibility before proceeding.

In step 414, the method can include passing the URL to the embedded internal resources feature.

This step can include integrating the new reporting tool into the IDE's embedded resources system. The URL, along with any necessary metadata about the tool, is provided to the component responsible for managing embedded resources. This process may involve updating configuration files, registering the tool with a central registry, or modifying IDE plugin settings. The system ensures that the new tool is properly categorized and tagged, allowing it to be easily discovered and selected when relevant to the current code context. This step may also involve setting up any necessary permissions or access controls to manage which developers or teams can use the new tool.

In step 416, the method can include determining whether the embedding process was successful.

This step can include verifying that the new reporting tool can be correctly loaded and displayed within the IDE. The system attempts to render the tool using the provided URL and checks that it appears as expected in the designated IDE view. This verification process may include checking that the tool receives the context parameters correctly, renders its interface elements properly, and can interact with the IDE as intended. If any issues are detected during this process, such as rendering errors or functionality problems, the method proceeds to step 418. If the embedding is successful, the method continues to step 420.

In step 418, the method can include debugging embedding issues.

If problems are encountered during the embedding process, this step can include investigating and resolving the issues. Developers may use IDE debugging tools, browser developer consoles, or specialized embedding diagnostics to identify the root causes of any problems. Common issues might include incorrect URL formatting, missing or malformed context parameters, content security policy violations, or incompatibilities with the IDE's embedding framework. The debugging process may involve iterative testing and refinement of the tool's code, URL construction, or embedding configuration. Once issues are resolved, the system reattempts the embedding process.

In step 420, the method can include testing the embedded tool's functionality.

After successful embedding, this step can include thoroughly testing the new tool to ensure it operates correctly within the IDE environment. Testers interact with the tool, verifying that all features and functions work as intended. This includes checking that the tool properly utilizes the provided context parameters, updates correctly when the code context changes, and integrates smoothly with existing IDE features. The testing process may involve a range of scenarios and edge cases to ensure robust performance under various conditions. Testers also evaluate the tool's performance impact on the IDE, ensuring that it doesn't significantly slow down or disrupt normal development activities.

In step 422, the method can include determining whether the tool functions correctly based on the testing results.

This step can include evaluating the outcomes of the functionality testing to decide if the tool is ready for deployment. The evaluation considers factors such as feature completeness, performance, reliability, and user experience. If any significant issues or shortcomings are identified during testing, the method proceeds to step 424. If the tool is deemed to be functioning correctly and meeting all requirements, the method continues to step 426.

In step 424, the method can include refining the tool or its embedding based on testing feedback.

If issues are identified during functionality testing, this step can include making necessary adjustments to improve the tool's performance or integration. This may include optimizing the tool's code, adjusting its user interface, refining how it processes context parameters, or modifying its interaction with the IDE. Developers work to address any bugs, performance issues, or usability concerns identified during testing. The refinement process may involve multiple iterations of changes and retesting until the tool meets the required standards for functionality and user experience.

In step 426, the method can include documenting the tool for other developers.

Once the tool is functioning correctly, this final step involves creating comprehensive documentation to help other developers understand and use the new embedded reporting tool. The documentation typically includes information on the tool's purpose, how to access it within the IDE, what context it uses, and how to interpret its output. It may also include examples of common use cases, troubleshooting tips, and any known limitations or caveats. The documentation is made available through appropriate channels, such as internal wikis, development guides, or inline help systems within the IDE. This ensures that the broader development team can effectively leverage the new tool in their workflows.

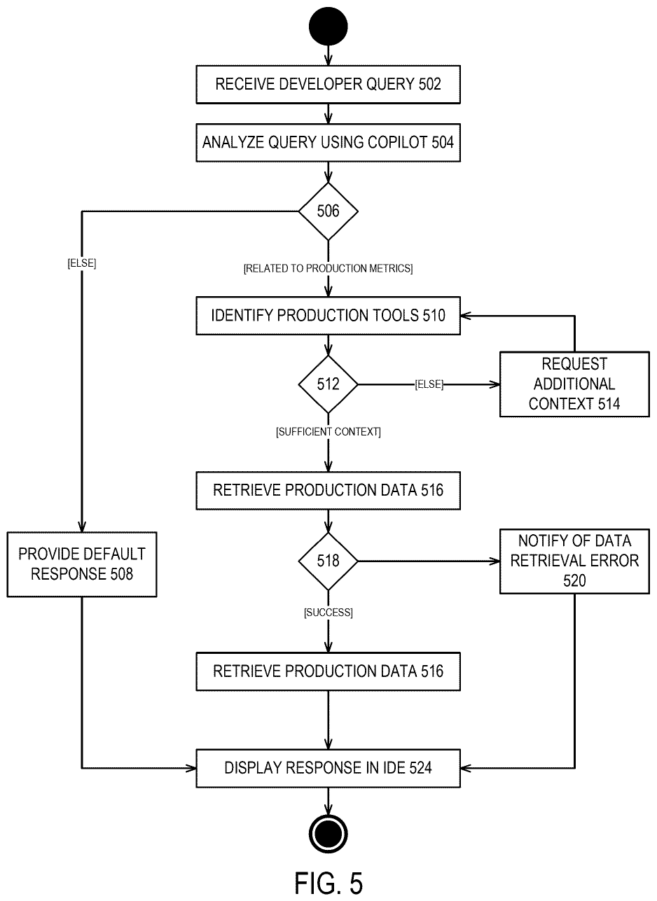

FIG. 5 illustrates a method for AI-assisted production reporting within an IDE.

In step 502, the method can include receiving a developer query in the IDE.

This step can include capturing and processing a query or request made by a developer within the IDE environment. The query can be input through various interfaces, such as a dedicated chat-like window, a command palette, or context menu options within the code editor. The system is designed to understand natural language queries, allowing developers to ask questions or request information in a conversational manner. The query reception mechanism is integrated seamlessly into the IDE, enabling developers to seek assistance without switching contexts or leaving their coding environment. The system may also support multimodal input, allowing developers to combine text queries with actions like selecting code snippets or pointing to specific parts of their project structure.

In step 504, the method can include analyzing the query using an AI copilot.

Once a query is received, it is passed to an AI copilot system for analysis. This AI system is designed to understand the context of the developer's work, the specifics of their query, and the broader implications within the software development lifecycle. The analysis process involves several substeps. First, the AI copilot performs natural language processing (NLP) on the query to extract its core intent and any key parameters or constraints. This NLP stage may use techniques such as named entity recognition to identify specific code elements, APIs, or metrics mentioned in the query. Next, the system analyzes the current IDE context, including the open files, the specific code being viewed or edited, and the overall project structure. This contextual information is crucial for providing relevant and accurate responses. The AI copilot then correlates the query intent with its knowledge base of software development concepts, best practices, and the specific architecture and patterns used in the project. This step helps the system frame the query within the appropriate technical domain. Finally, the system determines whether the query is related to production metrics or if it's a more general development question. This classification is critical for deciding how to proceed with answering the query.

In step 506, the method can include determining whether the query is related to production metrics.

Based on the analysis performed by the AI copilot, the system makes a decision about whether the developer's query pertains to production metrics and performance data. This determination is crucial as it dictates the subsequent steps in the process. The decision-making process considers various factors. It looks for the presence of keywords or phrases related to production environments, performance, user behavior, or system health. It also takes into account the context of the code being viewed or edited, and whether it's likely to have significant production implications. The developer's recent activity and whether they've been working with or inquiring about production-related matters is also considered. Additionally, the system examines any specific metrics or tools mentioned in the query. If the query is determined to be related to production metrics, the method proceeds to step 510. If not, it continues to step 508.

In step 508, the method can include providing a default response to the developer's query.

For queries not related to production metrics, the AI copilot generates a response based on its general software development knowledge. This response could include code suggestions, explanations of programming concepts, or guidance on best practices. The system leverages its understanding of the project context and the developer's current task to tailor the response appropriately. The default response mechanism ensures that the AI assistant remains helpful for a wide range of development queries, not just those specific to production metrics.

In step 510, the method can include identifying relevant production tools based on the query and context.

For queries related to production metrics, the system begins by identifying which production reporting tools are most relevant to the developer's question. This process involves mapping the query intent to specific categories of production data, such as performance metrics, error rates, or user engagement statistics. It considers the code context to determine which parts of the system are most relevant to the query. The process also evaluates the available production tools and their capabilities against the requirements of the query. User preferences and frequently used tools for similar queries in the past are taken into account. The tool identification process is designed to be both comprehensive and precise, ensuring that the most appropriate tools are selected to address the developer's query.

In step 512, the method can include determining whether there is sufficient context to proceed with data retrieval.

Before attempting to retrieve production data, the method checks whether it has enough contextual information to make a meaningful query to the production data sources. This step is crucial for ensuring that the data retrieved is relevant and accurate. The context sufficiency check considers factors such as the specificity of the developer's query and whether it provides clear parameters for data retrieval. It examines the current state of the code and whether it contains all necessary information, such as service names or API endpoints, to query the relevant production metrics. The availability of recent production deployments that match the current code state is also considered. Additionally, the system takes into account the developer's permissions and access rights to various production data sources. If the context is deemed insufficient, the method proceeds to step 514. If sufficient context is available, it continues to step 516.

In step 514, the method can include requesting additional context from the developer.

When the available context is insufficient, the system engages in a dialogue with the developer to gather the necessary additional information. This interaction is designed to be concise and focused, asking specific questions that will help clarify the query or provide missing details. The system may present options or suggestions to the developer, making it easier for them to provide the required context. This step ensures that the subsequent data retrieval and analysis are as accurate and relevant as possible.

In step 516, the method can include retrieving the relevant production data.

With sufficient context established, the system proceeds to fetch the required production data. This process involves constructing appropriate queries for each identified production tool or data source. These queries are executed, potentially in parallel for efficiency. The system handles authentication and authorization for secure access to production data systems. It manages the data retrieval process, including handling timeouts, retries, and partial data scenarios. Initial processing on the raw data is performed, such as filtering out irrelevant information or aggregating data points. The data retrieval step is optimized for performance, balancing the need for comprehensive data with the desire for quick responses within the IDE environment.

In step 518, the method can include determining whether the data retrieval was successful.

After attempting to retrieve the production data, the system evaluates the success of the operation. This evaluation considers several factors, including whether all requested data was successfully retrieved from the various sources. It assesses the quality and completeness of the retrieved data. Any errors or warnings encountered during the data retrieval process are noted. The system also evaluates the relevance of the retrieved data to the original query. If the data retrieval is deemed successful, the method proceeds to step 522. If it was unsuccessful or only partially successful, the method continues to step 520.

In step 520, the method can include notifying the developer of data retrieval issues.

When data retrieval is unsuccessful or incomplete, the method generates a notification to inform the developer of the issues encountered. This notification is designed to be informative yet concise. It provides a clear indication of which data could not be retrieved and possible reasons for the retrieval failure, such as network issues, permission problems, or data not being available for the specified time range. The notification includes suggestions for potential next steps or alternative approaches to get the required information. It also offers options for the developer to retry the data retrieval or modify their query. This step ensures transparency in the process and helps developers understand and potentially resolve any data access issues.

In step 522, the method can include generating a response with an embedded report.

Using the successfully retrieved production data, the AI copilot generates a comprehensive response to the developer's query. This response is not merely a raw data dump but an intelligent synthesis of information, tailored to address the specific question asked. The response generation process involves analyzing the retrieved data to identify patterns, anomalies, or insights relevant to the query. It correlates the production data with the current code context to provide specific, actionable insights. The system generates natural language explanations that interpret the data in the context of the developer's work. It creates visualizations or summary statistics that help convey complex information clearly and concisely. The AI-powered response also includes formulating recommendations or suggestions based on the insights derived from the data. The response is designed to be both informative and actionable, providing developers with clear insights that can guide their decision-making and coding efforts.

In step 524, the method can include displaying the response in the IDE.

The final step involves presenting the AI-generated response, complete with embedded reports and visualizations, within the IDE interface. This display is carefully designed to integrate seamlessly with the developer's workflow, providing information without disrupting their coding process. The display mechanism may include inline code annotations that provide context-specific insights directly alongside relevant code. It can also feature sidebar or panel views that offer more detailed reports and interactive visualizations. Pop-up overlays may be used for quick access to summary information with the option to expand for more details. The system integrates with the IDE's existing notification and information display systems. The displayed response is interactive, allowing developers to explore the data further, adjust parameters, or ask follow-up questions. It also includes options for developers to provide feedback on the usefulness of the response, helping to improve the system's effectiveness over time. This AI-assisted production reporting method enhances the development process by bringing relevant production insights directly into the IDE, contextualized by AI to provide maximum value to developers as they work on their code.

In some implementations, the method may provide notifications while testing user tasks, which would proactively alert quality assurance engineers to available metrics and insights during their testing processes. In some implementations, the method may utilize an expansion of AI-powered reporting context, where the system could leverage large language models to provide more nuanced and context-aware insights, potentially even suggesting code improvements based on production data.

The concept of embedded resources could also be extended to version control system hosts, allowing developers to access production insights directly from platforms like GitHub® or internal code repositories. This would provide valuable context during code reviews and pull request evaluations.

FIG. 6 is a block diagram of a computing device according to some embodiments of the disclosure.

As illustrated, the device 600 includes a processor or central processing unit (CPU) such as CPU 602 in communication with a memory 604 via a bus 614. The device also includes one or more input/output (I/O) or peripheral devices 612. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 602 may comprise a general-purpose CPU. The CPU 602 may comprise a single-core or multiple-core CPU. The CPU 602 may comprise a system-on-a-chip (SoC) or a similar embedded system. In some embodiments, a graphics processing unit (GPU) may be used in place of, or in combination with, a CPU 602. Memory 604 may comprise a memory system including a dynamic random-access memory (DRAM), static random-access memory (SRAM), Flash (e.g., NAND Flash), or combinations thereof. In one embodiment, the bus 614 may comprise a Peripheral Component Interconnect Express (PCIe) bus. In some embodiments, the bus 614 may comprise multiple busses instead of a single bus.

Memory 604 illustrates an example of a non-transitory computer storage media for the storage of information such as computer-readable instructions, data structures, program modules, or other data. Memory 604 can store a basic input/output system (BIOS) in read-only memory (ROM), such as ROM 608 for controlling the low-level operation of the device. The memory can also store an operating system in random-access memory (RAM) for controlling the operation of the device.

Applications 610 may include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 606 by CPU 602. CPU 602 may then read the software or data from RAM 606, process them, and store them in RAM 606 again.

The device may optionally communicate with a base station (not shown) or directly with another computing device. One or more network interfaces in peripheral devices 612 are sometimes referred to as a transceiver, transceiving device, or network interface card (NIC).

An audio interface in peripheral devices 612 produces and receives audio signals such as the sound of a human voice. For example, an audio interface may be coupled to a speaker and microphone (not shown) to enable telecommunication with others or generate an audio acknowledgment for some action. Displays in peripheral devices 612 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 612 may comprise any input device arranged to receive input from a user. An illuminator in peripheral devices 612 may provide a status indication or provide light. The device can also comprise an input/output interface in peripheral devices 612 for communication with external devices, using communication technologies, such as USB, infrared, Bluetooth®, or the like. A haptic interface in peripheral devices 612 provides tactile feedback to a user of the client device.

A GPS receiver in peripheral devices 612 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present application is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

We claim:

1. A method comprising:
receiving, by a processor, a request to view code in an integrated development environment (IDE);
extracting, by the processor, context information from the code;
selecting, based on the context information, at least one production reporting tool from a tool repository;
retrieving production data associated with the code from at least one data source;
generating a report using the production data; and
embedding the report within a user interface of the IDE while displaying the code.

2. The method of claim 1, wherein extracting context information comprises:
parsing the code to generate an abstract syntax tree;
analyzing the abstract syntax tree to identify code structures; and
determining a purpose of the code based on the code structures.

3. The method of claim 1, wherein selecting the at least one production reporting tool comprises:
querying a tool repository containing metadata about available production reporting tools;
matching the context information with the metadata; and
identifying tools applicable to the code based on matching the context information with the metadata.

4. The method of claim 1, wherein retrieving production data comprises:
authenticating with the at least one data source;
constructing queries based on the context information; and
executing the queries to generate performance metrics associated with the code.

5. The method of claim 1, further comprising:
monitoring changes to the code in the IDE;
updating the context information based on the changes; and
refreshing the report based on the context information.

6. The method of claim 1, wherein embedding the report comprises:
selecting a location within the IDE based on a type of the report;
generating a visualization of the production data; and
displaying the visualization in the location while maintaining visibility of the code.

7. The method of claim 1, further comprising:
analyzing the production data using an artificial intelligence model;
generating recommendations for code optimization based on an output of the artificial intelligence model; and
presenting the recommendations within the report.

8. A non-transitory computer-readable storage medium for tangibly storing computer program instructions capable of being executed by a computer processor, the computer program instructions defining steps of:
receiving, by a processor, a request to view code in an integrated development environment (IDE);
extracting, by the processor, context information from the code;
selecting, based on the context information, at least one production reporting tool from a tool repository;
retrieving production data associated with the code from at least one data source;
generating a report using the production data; and
embedding the report within a user interface of the IDE while displaying the code.

9. The non-transitory computer-readable storage medium of claim 8, wherein extracting context information comprises:
parsing the code to generate an abstract syntax tree;
analyzing the abstract syntax tree to identify code structures; and
determining a purpose of the code based on the code structures.

10. The non-transitory computer-readable storage medium of claim 8, wherein selecting the at least one production reporting tool comprises:
querying a tool repository containing metadata about available production reporting tools;
matching the context information with the metadata; and
identifying tools applicable to the code based on matching the context information with the metadata.

11. The non-transitory computer-readable storage medium of claim 8, wherein retrieving production data comprises:
authenticating with the at least one data source;
constructing queries based on the context information; and
executing the queries to generate performance metrics associated with the code.

12. The non-transitory computer-readable storage medium of claim 8, the steps further comprising:
monitoring changes to the code in the IDE;
updating the context information based on the changes; and
refreshing the report based on the context information.

13. The non-transitory computer-readable storage medium of claim 8, wherein embedding the report comprises:
selecting a location within the IDE based on a type of the report;
generating a visualization of the production data; and
displaying the visualization in the location while maintaining visibility of the code.

14. The non-transitory computer-readable storage medium of claim 8, the steps further comprising:
analyzing the production data using an artificial intelligence model;
generating recommendations for code optimization based on an output of the artificial intelligence model; and
presenting the recommendations within the report.

15. A device comprising:
a processor; and
a memory storing instructions that, when executed by the processor, cause the processor to perform steps of:
receiving, by a processor, a request to view code in an integrated development environment (IDE);
extracting, by the processor, context information from the code;
selecting, based on the context information, at least one production reporting tool from a tool repository;
retrieving production data associated with the code from at least one data source;
generating a report using the production data; and
embedding the report within a user interface of the IDE while displaying the code.

16. The device of claim 15, wherein extracting context information comprises:
parsing the code to generate an abstract syntax tree;
analyzing the abstract syntax tree to identify code structures; and
determining a purpose of the code based on the code structures.

17. The device of claim 15, wherein selecting the at least one production reporting tool comprises:
querying a tool repository containing metadata about available production reporting tools;
matching the context information with the metadata; and
identifying tools applicable to the code based on matching the context information with the metadata.

18. The device of claim 15, wherein retrieving production data comprises:
authenticating with the at least one data source;
constructing queries based on the context information; and
executing the queries to generate performance metrics associated with the code.

19. The device of claim 15, the steps further comprising:
monitoring changes to the code in the IDE;
updating the context information based on the changes; and
refreshing the report based on the context information.

20. The device of claim 15, wherein embedding the report comprises:
selecting a location within the IDE based on a type of the report;
generating a visualization of the production data; and
displaying the visualization in the location while maintaining visibility of the code.
